(19) United States
(12) Patent Application Publication
(10) Pub. No.: US 2008/0306721 A1
(43) Pub. Date: Dec. 11, 2008

(54) Dynamic-Verification-Based Verification Apparatus Achieving High Verification Performance and Verification Efficiency and the Verification Methodology Using the Same

(76) Inventor: Sei Yang Yang, Pusan (KR)

Correspondence Address: ROBERTS MLOTKOWSKI SAFRAN & COLE, P.C.;Intellectual Property Department, P.O. Box 10064, MCLEAN, VA, 22102-8064, US

(21) Appl. No.: 10/591,910

(22) PCT Filed: Mar. 9, 2005
(86) PCT No.: PCT/KR05/00668

§ 371 Date: Jul. 21, 2008

(30) Foreign Application Priority Data
Mar. 9, 2004 (KR) 10-2004-0017476
Mar. 16, 2004 (KR) 10-2004-0019066
Jul. 12, 2004 (KR) 10-2004-0055329
Nov. 8, 2004 (KR) 10-2004-0093309
Jan. 24, 2005 (KR) 10-2005-0007330

(51) Int. Cl. G06F 11/26; G06F 17/50

(52) U.S. Cl. 703/14

(57) ABSTRACT

The present invention relates to a simulation-based verification apparatus and a verification method, which enhance the simulation performance and efficiency greatly, for verifying a digital system containing at least million gates. Also, the present invention relates to a simulation-based verification apparatus and a verification method used together with formal verification, simulation acceleration, hardware emulation, and prototyping to achieve the high verification performance and efficiency for verifying a digital system containing at least million gates.

### FIELD OF THE INVENTION AND DESCRIPTION OF THE RELATED ART

1. Field of the Invention

The present invention relates to a technique for verifying a digital circuit or a digital system, and more particularly, to a verification apparatus which is capable of verifying a digital circuit or a digital system using a verification apparatus for system integration circuit design, and a method using the same. Even more particularly, the present invention relates to the verification apparatus which can increase the verification performance and reduce the verification time, and a method using the same.

2. Description of the Related Art

The present invention relates to a technique for verifying a digital system having at least several million gates, and more specifically to a verification apparatus which increases the verification performance and efficiency when a digital system having at least several million gates is verified by simulation, and a method using the same.

With the rapid development of integrated circuit design technology and semiconductor fabrication, the architecture of digital circuit designs has become very complex and the design complexity has grown to several million to several tens of millions of gates. The design having over hundred million gates is expected in the near future. However, as the competition in the market is getting more intense, the competitive products should be developed rapidly and the design verification takes up to 70% of total design time in recent chip design. Therefore, the need for efficient design verification method is growing to rapidly verify the designed circuits in automatic way. If the digital system is designed in a chip, the objects to be designed are two. One is DUV (Design Under Verification), and the other is test bench (abbreviated as TB thereafter). DUV is the design object that should be made eventually into chip(s) though the semiconductor fabrication process, and TB is the model of the environment where the corresponding chip(s) is mounted and operated. TB is used for the simulation of DUV. When DUV is verified by simulation, TB usually drives inputs to DUV and receives outputs from it. So far, to verify the digital circuits to be designed, Hardware Description Language (abbreviated as HDL thereafter), System Description Language (abbreviated as SDL thereafter), or Hardware Verification Language (abbreviated as HVL thereafter) is used. In the early design phase, HDL simulators (for example, Verilog simulator, VHDL simulator, SystemVerilog simulator, etc), or SDL simulators (for example, SystemC simulator, HW/SW co-simulator, etc) are used, and in some cases even HVL simulators (for example, Vera simulator, e simulator, etc) are also used together with the simulators mentioned above. As all of them are software-based approaches and the simulator must execute the software code consisting of instruction sequence, which models the circuit to be verified and the test bench, sequentially on a computer, the degradation of simulation performance is inversely proportional to the size of design. For example, many 10 million-gate designs are running in either a HDL simulator or a SDL simulator on the computer having the fastest processor at the speed of 10-100 cycles/sec range at RTL, and 1-10 cycles/sec range at gate level at most. However, as the total simulation cycles is needed in the range of a couple of million to a couple of billion to verify the design, the total simulation takes prohibitively long. There are some technologies that can reduce this long verification time. The first is to use a hardware-assisted verification system (such as simulation accelerator, hardware emulator, FPGA prototyping system, etc), and the second is to use a simulation farm which consist of multiple HDL simulators on one or more computers (for example, 100 units of workstations) in a high speed network. However, hardware-assisted verification systems cannot be used in the early design phase, their synthesis or compilation process takes much longer than that of HDL simulators, their use is much harder than HDL simulators, their purchasing and maintenance/repairing costs are large, and most of all, HDL simulators are much more favorable than hardware-assisted verification systems to either designers or verification engineers. Also, all hardware-assisted verification systems are used relatively in the restricted cases and to the limited number of customers because the original design codes, which are simulated by any of HDL simulators without any problems, cannot be executed in the systems. Increasing the performance of simulation by the use of simulation farms is possible only if there are at least two design codes or test benches. More over, even if there are more than one test benches, total simulation time is determined by the test bench responsible for the longest simulation time (for example, if the simulation time takes a week by a specific test bench, a week of simulation time cannot be reduced even with a simulation farm). This observation is also consistently true in the simulation with either SDL simulators or HVL simulators. Even worse, as the complexity of test bench is kept on increasing because there are varieties of components existing inside TB (for example, random stimulus generators, monitors, checkers, coverage tools, response checkers, etc), which is described in higher level of abstraction, the increased TB overhead is one of main components that constitute the slow down of simulation performance. The various test benches, or in some cases, some components in DUV are absolutely necessary in test bench automation, coverage-driven verification, or assertion-driven verification for recent advanced verification technology, but their use results in the slow down of simulation significantly. Even worse, throughout using the advanced verification technology, only the existence of bugs in the design can be determined, or at best the possible buggy areas in the design can be known, but not possible to identify the exact location of bugs in the design. Intelligent human can be only responsible for identifying and eliminating the bugs in the design. To do this, the designers or verification engineers need to examine the signals or variables in DUV, and even in TB occasionally after probing them during the simulation. However, when these two situations exist together, the speed of simulation is degraded even more.

Also, when TB is described in HVL, API(Application Program Interface) of HDL simulators, VPI/PLI/FLI, must be used in general, their use makes the simulation speed even slower. More over, the most of designs starts at the register transfer level (abbreviated RTL afterward), and are synthesized into a net-list by some logic synthesis technology. At the other sides, to cope with the increased design complexity, there are some new attempts by starting the design by describing DUV and TB at higher level of abstraction such as behavioral level or system level, translating into a RTL automatically, and finally synthesizing into a net-list. But, their success is very unclear because most hardware designers opt to design at RTL, and the quality of design starting at more abstraction level is not good as much as one starting at RTL in terms of operation speed/area. Recent a couple of tens of million gate designs are usually SOCs which have one or more embedded processor. These SOCs also embeds significant software codes which drive those embedded processors. Therefore, in SOC design co-design and co-verification is absolutely needed to develop software together with the development of hardware concurrently. However, DUV described at RTL is too slow to be a platform for developing embedded software, but software developers need a platform on which their software can be executed fast enough for the development during the hardware design is under way.

At present, the most widely used simulation is event-driven simulation. Besides, there are cycle-based simulation, and transaction simulation. In terms of abstraction level, event-driven technique is less abstract than cycle-based one, and cycle-based one is less abstract than transaction-based one. Cycle-based simulation is about 10-100 times faster than event-driven simulation, but imposes many constraints on the designs. Therefore, hardware designers are completely ignoring any cycle-based simulations and favorably using some event-driven simulations. Also, at present event-driven simulation, cycle-based simulation, and transaction-based simulation are used separately. Overall, these situations greatly hinder the verification with the high efficiency and performance.

### SUMMARY OF THE INVENTION

The purpose of the present invention is to provide a simulation-based design verification apparatus and a design verification method by using it for designing very large scaled digital systems. More specifically, the technology in the present invention is about the verification apparatus which uses simulation, and if necessary, formal verification, simulation acceleration, hardware emulation, and(or) prototyping (called a verification platform in a common name) together to increase the efficiency and performance of verification for verifying at least multi-million gate digital designs, and the verification method using the same.

To debug design errors after simulation, the visibility on signals or variables in the design code is needed. But, the problem is it is impossible to predict which signals or variables are needed for the visibility before starting the execution of a verification platform. Therefore, it is usual that the simulation is run after choosing all signals and variables in the design code for probing as the candidates for dumping. But, dumping all signals and variables in the design code during the simulation easily slow down the simulation speed by factor of 2 to 10 times or even more than without dumping any signals or variables in the code. One of the objectives in the present invention is to provide an automatic method and a verification apparatus for it which can identify the locations of bugs in the design code while reducing the simulation time, compared to the traditional methods which require dumping all signals and variables in the design code at the beginning of simulation. Another objective in the present invention is to provide an automatic method and a verification apparatus for it which maintains the high visibility with the high performance when using test bench automation, coverage-driven verification, or assertion-based verification together with simulation in advanced verification. Still, another objective in the present invention is to provide an automatic method and a verification apparatus for it which keeps the high visibility for DUV, and simultaneously reduces the total simulation time greatly by using the simulation results of the higher abstraction level in the simulation at the lower abstraction level in the top-down design process. This eventually contributes to the efficient hardware verification, software verification, or hardware/software co-verification. Still, another objective in the present invention is to increase the overall verification performance and efficiency existed in the different level of abstractions by using the verification results of a higher level of design abstraction in the verification at a lower level of design abstraction through an automatic way, thereby accelerating the verification at the lower level of design abstraction, and if necessary increasing the verification efficiency at the lower level of design abstraction utilizing the verification results of the higher level of abstraction as a reference. Still, another objective in the present invention is to increase the overall verification performance and efficiency existed in the different level of abstractions by using the verification results of a higher level of design abstraction in the verification at a lower level of design abstraction through an automatic way, thereby accelerating the verification at the lower level of design abstraction, and if necessary increasing the verification efficiency at the higher level of design abstraction utilizing the verification results of the lower level of abstraction as a reference. Still, another objective in the present invention is to increase the overall verification performance and efficiency by selectively using transaction-level simulation, cycle-based simulation, or(and) event-driven simulation in the optimal way in the process of the verification flow from top level of design abstraction to bottom-level of design abstraction, and using the verification results of a specific level of design abstraction in the verification at a different level of design abstraction. Still, another objective in the present invention is to increase the total verification performance and efficiency by using at least one or more of formal verification, simulation acceleration, hardware emulation, or prototyping together with simulation.

### BRIEF DESCRIPTION OF THE DRAWINGS

The accompanying drawings, which are included to provide a further understanding of the invention and which constitute a part of this specification, illustrate embodiments of the invention and together with the description serve to explain the principles of the invention.

In the drawings:

FIG. 1 is an example of the schematic view of the design verification apparatus in accordance with the present invention;

FIG. 2 is another example of the schematic view of the design verification apparatus in accordance with the present invention;

FIG. 3 is a schematic view of a simulation process by the method proposed in the present invention;

FIG. 4 is a schematic view of a bug finding and removing process throughout the simulation proposed in the present invention, which consists of the 1^{st} simulation as the front-stage simulation and the post-1^{st} simulations as the back-stage simulation;

FIG. 5(a) is a schematic view showing a verification process in the verification using the apparatus showing in FIG. 1 or FIG. 2;

FIG. 5(b) is a schematic view showing another verification process in the verification using the apparatus showing in FIG. 1 or FIG. 2;

FIG. 6(a) is a schematic view showing a verification process in which the post-1^{st} simulations as the back-stage simulation are executed in parallel, using the verification apparatus in FIG. 2;

FIG. 6(b) is a schematic view showing another verification process, in which the post-1^{st} simulations as the back-stage simulation are executed in parallel, using the verification apparatus in FIG. 2;

FIG. 6(c) is a schematic view showing another verification process, in which the post-1^{st} simulations as the back-stage simulation are executed in parallel, using the verification apparatus in FIG. 2;

FIG. 6(d) is a schematic view showing another verification process, in which the post-1^{st} simulations as the back-stage simulation are executed in parallel, using the verification apparatus in FIG. 2;

FIG. 7 is another example of the schematic view of the design verification apparatus in accordance with the present invention;

FIG. 8 is an example of the schematic view of the design verification apparatus in accordance with the present invention which consists of verification software of the present invention, at least one computer having at least one simulator, and at least one hardware-assisted verification platform;

FIG. 9 is an example of the schematic view of the design verification apparatus in, accordance with the present invention which consists of verification software of the present invention, at least two computers having at least two simulators, at least one hardware-assisted verification platform, and a computer network which connects among them;

FIG. 10 is an another example of the schematic view of the design verification apparatus in accordance with the present invention which consists of verification software of the present invention, at least one computer having at least one simulator, and at least one hardware-assisted verification platform;

FIG. 11 is an example of the schematic view showing the reuse of the previous verification results in the verification using the apparatus in FIG. 8;

FIG. 12 is an example of the schematic view showing the reuse of the previous simulation results in the verification using the apparatus in FIG. 1;

FIG. 13 is an example of the schematic view showing the fast execution of verification process by re-using the verification results of any design objects unaltered on an arbitrary verification platform after some design objects are modified;

FIG. 14 is an example of the schematic view showing the fast execution of verification process by re-using the verification results of any design objects unaltered on an arbitrary hardware-assisted verification platform after some design objects are modified;

FIG. 15 is an example of the schematic view showing the fast execution of simulation process by re-using the simulation results of any design objects unaltered on a simulator after some design objects are modified;

### EXPLANATION OF SYMBOLS IN FIGURES

12: Test bench design object
14: DUV design object
15: Input information for replay
16: Design block design object
20: Design object modified
22: Partial dynamic information collected before the design change
27: Hardware-assisted verification platform
28: A system software component in a prototyping system
29: A system software component in a simulation accelerator
30: A system software component in a hardware emulator
31: The software module in the verification software which instruments either the additional code or the additional circuit to either a design code or a synthesized net-list in an automatic way
32: Verification software
34: Simulator
35: Computer
36: A hardware component in a hardware emulator platform
37: A hardware component in a simulation accelerator platform
38: A hardware component in a prototyping system platform
42: Model checker or property checker
44: The software module in the verification software which is in charge of transferring files or data among more than one computers during the verification, executing the 1^{st}, verification run, preparing the post-1^{st} verification runs, and executing the post-1^{st} verification runs.

### DETAILED DESCRIPTION OF THE PREFERRED EMBODIMENT

To achieve the above mentioned objectives, the design verification apparatus of the present invention provides a verification software, one or more computer installed one or more verification platform (simulators, for example). The verification software is executed in a computer, and if there are more than one computer in a said design verification apparatus, those computers can transfer the files among them as they are connected in a computer network. Said one or more verification platform could be simulators, simulation accelerators, formal verification tools such as model checkers or property checkers, hardware emulators, or prototyping systems, but from now on they are meant simulator otherwise specifically mentioned.

If said one or more verification platform is(are) simulator(s), then they could be event-driven simulators, event-driven simulators and cycle-based simulators, cycle-based simulators, cycle-based simulators and transaction-based simulators, or event-driven simulators and cycle-based simulators and transaction-based simulators. The verification apparatus and verification method proposed in the present invention can be used both the gate-level verification using synthesized net-lists, the and timing verification using timing information back-annotated from the placement and routing to the gate-level net-list as well as the functional verification using original design codes. However, the detailed description is mainly focused on the functional verification because same techniques are easily applicable to gate-level verification or timing verification as well. Moreover, the functional verification can be done at RTL(Register Transfer Level), but also durable at behavioral-level or transaction-level which is even higher abstraction level than RTL. But, the detailed description is also assumed that the functional verification is at RTL mostly. Besides, the proposed method can be even applicable to the hybrid-level of verification which spans more than one design abstraction level. Said verification software instruments the additional code or circuit after reading the design codes in an automatic way. The instrumented code or circuit are basically additional HDL codes, SDL codes, HVL codes, C/C++ codes, simulation commands, or even more than one of those. During the simulation, they make possible to save either the simulation states or the states of design objects (to be explained later) which needs the visibility in DU and even the states of TB in some cases at the regular interval or more than one discrete simulation times, and later to start re-simulations from those saved simulation states or design objects states when the visibility is required. If the design states of one or more design objects in DUV, which requires the visibility, are saved but the states of TB are not saved, then the values on all of inputs and bi-directional input/outs in input mode are saved during the entire simulation period. The saving could be by every event, every cycle, or every transaction. A simulation state is represented by all dynamic and static information of a simulator at the specific simulation time during the execution of simulation. This is pretty similar to the state information of a program(process or thread) that makes possible the context switching between wait and resume in the multi-programming environment. A design state of a design object is represented by the values of all signals and variables in the design object. The design states of a design object can be classified into a complete design state or an incomplete design state, and minimal design state is a special case of incomplete design state. A complete design state of a design object is defined by the values of all signals and variables at a specific simulation time in the design object, and an incomplete design state of a design object is defined by the value(s) of at least one signal or variable at a specific simulation time in the design object. Also, a minimal design state in a design object is defined by the values of all signals or variables in the design object which represent the outputs of storage elements (flipflops, latches, or memory cells), and if combinational feedback loops exist in the design object, any signals and variables on each loop. A TB state is defined by the values of all variables and signals in TB at a specific simulation time. When the simulation is resumed from either one of the saved simulation states, or one of the saved design states of design objects in DUV and in some cases one of the saved TB states together (if the design states of the design objects in DUV are saved but the TB states are not saved, then the simulation should be resumed from one of the saved design states of design objects in DUV with the values of all inputs and all bi-directional input/outs in input mode saved in every event, every cycle, or every transaction during the entire simulation period), the dumping on either all signals and variables or some specific signals or variables in the design codes can be carried out during the re-simulation. When using HDL simulators (for example, Verilog simulators, VHDL simulators or SystemVerilog simulators), an example of saving simulation states is to use a simulation system task, save (in case of NC-Verilog, Verilog-XL, or VCS) or checkpoint (in case of ModelSim) command, and an example of re-simulating with a specific simulation state is to use another simulation system task, restore (in case of NC-Verilog, Verilog-XL, or VCS) or restart (in case of ModelSim) command. Also, to re-simulate from a specific design state of one or more design objects previously saved as the initial state, the simulation should be started with said signals and variables in said design objects having said previously saved values. To do this, various methods in simulators, which provide controllability over the design, can be used. XMR(Cross Module Reference), force/release procedural statement, or some system tasks such as PLI/VPI/FLI are some of examples that can provide controllability. Therefore, the verification software in said verification apparatus of the present invention instruments the additional code or circuit to the original code, and these instrumented codes or circuits are responsible for doing these explained above in an automatic way. Such simulation technique can increase the performance and efficiency of the verification with following reason. As mentioned already, it is inevitable to probe some specific signals or variables in the design code at some specific period of simulation time to find and correct design errors. However, the problem lies in the fact that it is not possible to predict which specific signals or variables in the design are need to be probed at which specific period of simulation time prior to a simulation run. Therefore, it is possible to select some signals or variables to be probed only after a simulation is run at first and its result is evaluated. Then, while the 2^{nd} simulation is executed from simulation time 0 until the time when the 1^{st} simulation is terminated, the dump on those selected signals or variables is carried out during a specific simulation period. But, the design error cannot be located at the 2^{nd} simulation, new signals or variables must be selected for probe and another simulation run needs to be executed from the simulation time 0 again. This process must be repeated many times until the location of the design bug is finally identified. This repeated many simulation runs contribute very long overall verification time as every simulation run needs to start at the simulation time 0. To avoid these repeated simulations, the 1^{st} simulation run should be executed while dumping all signals and variables in the design code after selecting all of them to be probed before starting the simulation run. However, the simulation time could be easily increased by the factor of 2 to 10 times or even more if the dumping over all signals and variables in the design code is carried out in the simulation than the simulation time without dumping. Moreover, the data size of simulation waveform dumped during entire the simulation time for all signals and variables in the design code could be easily exceeded to couples of tens to hundreds of giga-bytes. To save this huge simulation waveform data, a very large capacity of hard disk is required and the bring-up time of this data, which has stored in a specific format (for example, VCD/extended-VCD in Verilog, FSDB from Novas, or simulator-vendor specific compressed file format such as SHM/VCD+) in a hard disk, to any waveform viewer takes a very long time. All of these also contribute the increase of total verification time. The simulation technique proposed in the present invention consists of a pair of simulation runs which are divided into front-stage simulation run and back-stage simulation runs. The front-stage simulation run is executed as fast as possible by not to dump all of signals and variables in the design code. But, during this 1^{st} simulation run, the simulation states, or the design states of one or more design objects in DUV, which need the visibility, and if necessary the states of TB as well(if the design states of the design objects in DUV are saved but the TB states are not saved, then instead of saving TB states all inputs and all bi-directional input/outs in input mode are saved in every event, every cycle, or every transaction during the entire simulation period), S0, S1, . . . , Sn, are saved at the regular interval (for example, every 100,000 nano-sec or every 50,000 simulation cycles after the simulation run starts) or some specific simulation times t0, t1, . . . , tn so that any post-10 simulation run can begin not from the simulation time 0 but from a simulation time which is very close from the simulation time which users have a concern to watch. The saving of design states of design objects or values on inputs/outputs/inouts can be done by executing some dump commands (for example, some PLI system tasks such as $dumpvars, $dumports, etc). If the simulation states, or the design states of one or more design objects in DUV, which need the visibility, and if necessary the states of TB as well(if the design states of the design objects in DUV are saved but the TB states are not saved, then instead of saving TB states all inputs and all bi-directional input/outs in input mode are saved in every event, every cycle, or every transaction during the entire simulation period) are saved at one or more simulation times, any post-1^{st} re-simulation run can begin not only from the simulation time 0 but also from any simulation time of t0, t1, . . . tn. Therefore, the debugging for a design can be done quickly and it could be a very efficient verification method as it can reduce the verification time greatly compared to the conventional simulation-based verification methods. We'll call this simulation method as Simulation-Method-A.

Another method is to use the divide & conquer approach which utilizes the hierarchical structure existed in DUV or TB in a design code. In this case, the verification software imports the design code and performs a partition on DUV and TB so that the design code is partitioned into more than one design blocks (let's assume the design code is partitioned into M design blocks), and selects all of inputs and inouts of each partitioned design block as the candidates for probe, and instruments the additional code or design which is responsible for the dumping the selected signals to be probed at the 1^{st} simulation run, which is the front-stage simulation. Here, the design blocks include both DUV and TB also. Also, there are many sub-modules which are below DUV and TB in the hierarchy, and these sub-modules are also design blocks. We'll call any design block, DUV, TB, or even the combination of these as a design object. Therefore, DUT itself is a design object, so is each of sub-design blocks or even combined two or more sub-design blocks. After dumping the all of inputs and inouts of each design block during the 1^{st} simulation run, which is the front-stage simulation, into a set of files, these dump data are converted into M TBs, and compiled with M design blocks to generate M simulation executable files by using the verification software in the present invention. We'll call this simulation method as Simulation-Method-B. In Simulation-Method-B, instead of producing VCD or FSDB, it is possible to produce one or more TB files directly using VPI/PLI/FLI during the 1^{st} simulation run. In this case, the translation process from VCD/FSDB into TB could be eliminated.

Compared to the traditional simulation techniques, above two techniques can not only provide the high visibility on the design objects without scarifying the simulation speed severely, but also even increase the simulation speed greatly without using any hardware-assisted verification platform(for example, hardware emulator, or FPGA prototyping platform, etc) if the front-stage simulation and the back-stage simulation are executed at different levels of abstraction (will be explained more later). It is also possible to combine both Simulation-Method-A and Simulation-Method-B. However, both Simulation-Method-A and Simulation-Method-B can have following problems. For Simulation-Method-A, if the simulation period at a post-1^{st} simulation run, which is back-stage simulation, (ts, te) is quite long, the simulation time could be also long as the total number of n+1 sequential simulation runs are required at ti, ti-1, ti-2, . . . , ti-n times although it could be less than the time required with conventional simulation. For Simulation-Method-B, if the number of design blocks to be simulated at a post-1^{st} simulation run, which is back-stage simulation, (ts, te) is quite many, the simulation time could be also long as many sequential simulation runs are required although it could be less than the time required with conventional simulation. However, if simulators are two or more and the multiple computers, on which the simulators are executed, are connected in a network (for example, the X numbers of simulators are installed on the X numbers of computers), the post-1^{st} simulation runs, which is the back-stage simulation, can be done in parallel. As these parallel simulation runs are completely independent with each other, any post-1^{st} simulation runs can be very fast. We'll call the parallel execution in Simulation-Method-A as the temporally parallel execution as it parallelizes the multiple executions in time, and the parallel execution in Simulation-Method-B as the spatially parallel execution as it parallelizes the multiple executions in space.

Comparing the objectives of 1^{st} simulation which is the front-stage simulation and post-1^{st} simulation which is the back-stage simulation, it is known the post-1^{st} simulation takes more time as it provides the visibility to DUV and in some cases TB as well, and the methods proposed in the present invention can reduce this greatly by using said temporal parallelism and spatial parallelism. However, to improve the total simulation performance further, it is also important to run the 1^{st} simulation run, which is the front-stage simulation, as fast as possible while gathering the simulation result that contains the necessary information for one or more post-1^{st} simulation runs. There are many ways to achieve this. First method among them is to execute the 1^{st} simulation run, which is the front-stage simulation, in parallel also on two or more computers. In this case, as each simulator cannot be run independently with each other, but co-executed together it is very possible to have significant communication and synchronization overheads. Second method is to simulate with the new code which is translated for faster 1^{st} simulation from the original code, and has same functionality as the original one but different syntax. The translation is basically to convert some syntax in the original code which takes long simulation time into a new functionally equivalent syntax which can be simulated faster. Eliminating some loop statements by un-rolling the loops, removing unnecessary lists in the sensitivity lists, eliminating the syntax related to delay constructs in some cases, having minimal procedural blocks by combining some of them in Verilog, having minimal processes by combining some of them in VHDL, changing some continuous assignments to procedural assignments and using different sensitivity list from the original for being evaluated less in Verilog, changing some concurrent assignments to processes and using different sensitivity list from the original for being evaluated less in VHDL, changing some continuous assignments to procedural assignments and using sensitivity list being evaluated less in Verilog, changing some concurrent assignments to processes and using sensitivity list from the original for being evaluated less in VHDL, adjusting the sensitivity list in the corresponding always blocks and processes for being evaluated less, and eliminating some signals or variables in the original code which are unnecessary for 1^{st} simulation are some of those examples. In this process, it is also possible to convert the design code into a structural description globally or partially, and temporarily or permanently using fast logic transformation or logic synthesis. Moreover, for the simulation efficiency it could be simulated after representing some parts of converted design in BDD(Binary Decision Diagram) or MDD(Multi-valued Decision Diagram). Third method is to simulate the 1^{st} simulation run, which is the front-stage simulation, at the high level of abstraction and the post-1^{st} simulation runs, which are the back-stage simulation, at the low level of abstraction using the simulation results at the high level of abstraction. As the detailed examples, if an event-driven simulation is used at the post-1^{st} simulation runs, which are the back-stage simulation, then a cycle-based simulation which is 10 to 100 times faster than the event-driven simulation is used at the 1^{st} simulation run, which is the front-stage simulation. For the third method, the original design code written in either Verilog or VHDL can be converted into a SystemC code either manually or automatically (for example using HDL2SystemC translation tool), and a SystemC simulator is used. In general, as the event scheduler in the SystemC simulators is very right, it can be run faster than either Verilog or VHDL simulators. In case of second and third methods, while the 1^{st} simulation run which is the front-stage simulation is being carried out with either a SystemC simulator or a cycle-based simulator, the simulation states, or the design states of one or more design objects in DUV, which need the visibility, and if necessary the states of TB as well(if the design states of the design objects in DUV are saved but the TB states are not saved, then instead of saving TB states all inputs and all bi-directional, input/outs in input mode are saved in every event, every cycle, or every transaction during the entire simulation period), are saved at the regular interval or some specific simulation times so that any post-1^{st} simulation run can run in parallel with two or more HDL simulators on two or more computers. To do this, each sub-simulation in a run of one or more post-1^{st} simulation runs is executed after initializing its initial state to a design state, which is saved at one or more simulation times at the 1^{st} simulation run that is the front-stage simulation. For TB for the post-1^{st} simulation run which is the back-stage simulation, same TB for the 1^{st} simulation run which is the front-stage simulation can be used. But also for the second and third methods, as it is not possible to use any simulation states as the different simulators are used for one for the 1^{st} simulation run and the other for the post-1^{st} simulation runs, all inputs and all bi-directional input/outs in input mode are saved, if TB states are not saved, in every event, every cycle, or every transaction during the entire simulation period of the 1^{st} simulation run (for example VCD dump or FSDB dump, etc) and are translated into a set of new TBs which use for the post-1^{st} simulation. If newly generated a set of TBs is used instead of an original TB, the compilation time can be increased due to the increase of file size for TBs, but the elapsed time for running TBs in the simulation run time is reduced as their structure is the form of simple patterns.

Moreover, the technique mentioned above can use the results of RTL simulation using a RTL design code efficiently in the debugging for the gate-level simulation in which the gate-netlist is synthesized from the RTL code, and if necessary the timing information is back-annotated from the placement and routing. More specifically, the event-driven simulation or cycle-based simulation is used for the first simulation run, which is the front-stage simulation with a RTL design code while saving the design states of the design code at specific simulation times, then for the one or more post-1^{st} simulation as the back-stage simulation the gate-level simulation is carried out in parallel by utilizing those design states of the RTL design code saved at the first simulation. Above said gate-level simulation could be the timing simulation using SDF(Standard Delay Format), or the functional simulation at the gate level without using any timing information. As explained earlier, if the 1^{st} simulation is executed at higher level of abstraction than the post-1^{st} simulation while saving the dynamic information(for example, the minimal design state information of the design objects to be verified and, if necessary inputs information included, or the complete design state information of the design objects to be verified) of one or more design objects in DUV which need visibility, the post-1^{st} simulation as the back-stage simulation is using said dynamic information, and if two simulation results of the 1^{st} simulation and post-1^{st} simulation are same, then a pair of simulation which uses the different level of abstraction for the 1^{st} simulation and the post-1^{st} simulation (for example, cycle-based simulation at RTL for the 1^{st} simulation and event-based simulation at RTL for the post-1^{st} simulation) can run much faster (increasing simulation performance greatly) than a pair of simulation which uses the same level of abstraction (for example, event-based simulation at RTL for both the 1^{st} and post-1^{st} simulations).

Besides of the simulation performance increase when the two simulation results of the 1^{st} simulation and post-1^{st} simulation are same, there is another important merit when two simulation results of the 1^{st} simulation and 1^{st} simulation even are not same. The top-down design methodology is widely used in the most of modern designs. In this methodology, along to the design creation from the high-level of abstraction to the low-level of abstraction the verification should be also carried out through the same path, i.e. from the high-level of abstraction to the low-level of abstraction (for example, from behavioral to RTL, and from RTL to gate-level). As the method mentioned in the present invention can allow to use the simulation results at higher level of abstraction to the simulation at the lower level of abstraction (for example, using the simulation results at behavioral level to the simulation at RTL, the simulation results at RTL to the simulation at gate level, etc), the design consistency can be systematically and efficiently verified during the verification process. Therefore, this simulation method is a new verification methodology which can reduce not only the total debugging time, but also the total verification and design time. The advantage is similar to one from the Gain-based Synthesis (GBS), which is using the physical synthesis, proposed by Magma Design Automation, Inc. which had been a big success in the design implementation phase. The biggest problem in the chip designs is it is highly possible to incur too many iterations in the design and verification processes which result from the different results in the later stages of design cycles from the predicted one in the earlier stages of design cycles, which largely comes from raising the level of design abstraction further for coping with highly complex design problems. But, as both the proposed method in the present invention and the GBS method can provide the maximal consistency in the refinement process from the high level to the low level of the abstraction, it can commonly prevent the excess iterations. As the verification results at the higher level of the design abstraction is able to be a reference (or a golden), the overall verification and design process can be carried out quickly as much as possible. There are many clear advantages that the use of the simulation results at the higher level of the design abstraction in the simulation at the lower level of the design abstraction by combining multiple simulation results at two or more different levels of the abstraction. In the performance point of view it is mostly desirable to simulate the entire DUV at the higher level of the abstraction, but the concept explained above can be still applicable even when only one or more specific design objects in DUV are described at the higher level. For example, let's assume there are five design blocks B0, B1, B2, B3, and B4 in a DUV, and B2, B3, and B4 are written in cycle-based SystemC descriptions, but B0, and B1 in event-driven Verilog RTL. In this case, as a cycle-based simulation for B2, B3, and B4 is co-executed together with an event-driven simulation for B0, and B1, the simulation at the higher level of the abstraction is carried out in DUV partially for higher simulation speed. In general, the simulation results at the higher level of the abstraction can be thought as a special case of modeling process from the lower level of the abstraction. Therefore, even in this special case, it should be guaranteed that DUV must be operated correctly (in other words, to make a design robust the simulation results of two different abstraction levels for the front-stage simulation and the back-stage simulation should be same). From this fact, the simulation results at the higher level of the abstraction could be the role of a very useful reference in most cases. Therefore, two or more two-stage simulation runs at different abstraction levels and the design debugging method through the consistency checking of those simulation results are a new very effective technique for the verification. Similarly, it is also possible to use of the simulation results at the lower level of the design abstraction in the simulation at the higher level of the design abstraction by combining multiple simulation results at two or more different levels of the abstraction.

The verification apparatus and verification method previously explained can be applicable to the case in which one or more simulation accelerator(s), hardware emulator(s), prototyping system(s), formal tools(s) such as model checker(s) or property checker(s) is used in addition to simulator(s). More specifically, the 1^{st} verification run, which is the front-stage verification, uses one or more simulator(s), simulation accelerator(s), hardware emulator(s), prototyping system(s), formal tools(s) such as model checker(s) or property checker(s), or any combination of those to save the minimal information (for example, the state information of one or more design objects in DUV to be verified at one or more verification times, and if necessary, values of all inputs and inouts in input mode of said design objects during the entire verification period) which requires to execute at the post-1^{st} verification runs, which is the back-stage verification, with one or more simulator(s), simulation accelerator(s), hardware emulator(s), prototyping system(s), formal tools(s) such as model checker(s) or property checker(s), or any combination of those in either sequential or parallel.

Moreover, it is possible to quickly get the dynamic information on one or more design objects in DUV during a verification run (for example, VCD or FSDB dump in DUV and TB during the simulation run) with the two-stage verification runs which consist of the front-stage verification run and the back-stage verification runs. The dynamic information obtained in the verification run Vt can be reused entirely or partially in other verification run Vt+j after Vt (for example, the verification run to examine the correctness of a design modification) so that Vt+j can be executed even faster. Such debugging process, we'll call the rapid execution of a verification run as the incremental verification, which makes sure the design bug is actually removed, and there are two cases where the dynamic information can be reused.

First, the reuse could be applied in the case of regression testing, which is needed whenever there is any design modification during the debugging, and the case of assuring the correctness of modification after the design object has been modified. In these cases, a verification run is not carried out with the entire design object (including both DUV and TB). Instead, during one or more specific verification periods (for example, from the verification time 0 to tm), one or more design objects which are modified, DO(mod) only are executed at faster speed, and during remaining verification times (for example, after tm) the entire DUV and TB are executed. The critical element for this method is to identify one or more periods in which only one or more design objects, that are modified, can be executed. This can be done by comparing, in real time, the dynamic information of modified design objects after modification with one which has been already obtained before modification. Also, it is necessary to choose the modified design objects, DO(mod), properly. To obtain the simulation speed-up more in the simulation after design modification in simulation-based verification, the boundary of DO(mod), i.e. the size of DO(mod), should be small. But, because the execution speed of hardware-assisted verification platforms is almost independent of the design size, it is not necessary to keep the boundary of DO(mod) small if a hardware-assisted verification platform(for example, simulation accelerator) is used (For example, in case of simulation acceleration, the entire DUV can be selected as DO(mod) even one of lower-hierarchy design objects inside DUV only is modified. But, in simulation that lower-hierarchy design object should be selected as DO(mod)). One example of a specific method is following (we'll call this as the checkpoint-based method). It is possible to achieve a verification run with both a precision and a high performance if at each verification run in the regression test after design modification, comparing all values on the outputs and inouts ports in out mode of modified design objects, Vi(post_o), with all values on same ports of same design objects saved before design modification, Vi(pre_o), in real time, only modified design objects are executed with the replaying input stimuli or the input stimuli portion of replaying input/output stimuli, previously saved in a specific format (for example, the form of TB, the VCD format, or the binary format, etc) from the verification run before design modification, from the verification time 0 up to the verification time when Vi(post_o) and Vi(pre_o) are become different (let's call this time as tm afterward). Only after tm, the whole design objects including both all modified design objects and unmodified design objects are simulated together. But, it is absolutely necessary to align two verification times for the state information of modified design objects and that of unmodified design objects at tm, when two compared values become different and all design objects are simulated together. One of effective way for doing this is to save the state information of design objects one or more time regularly (for example, twenty saving in total) during a verification run before design modification, and to use them. One method to save the dynamic information will be explained in detail below.

If the verification platform is a simulator, there are two ways. One is to save the simulation states one or more times before the design objects are modified, and use them later. This is because the simulation state has any design states information completely. There are many techniques to save simulation states. To most convenient one is to use a simulation state saving command (for example, save or checkpoint commands in HDL simulators) built in any simulators, or the snapshot for an arbitrary program. Second way is to save the design states one or more times before the design objects are modified during the verification run (for example, simulation or simulation acceleration), and use them later. This method is especially useful when a hardware-assisted verification platform is used. The reason is any hardware-assisted verification platforms do not provide snapshot/restart capability unlike to simulators.

A preferred embodiment of the present invention will be described below, with reference to the accompanying drawings.

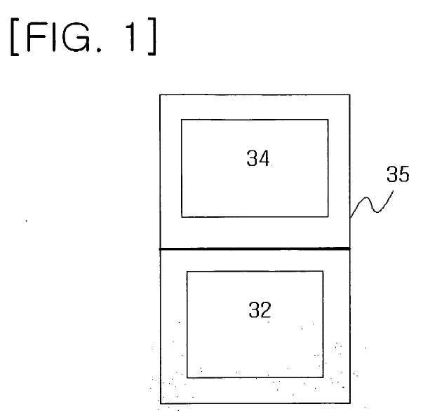

FIG. 1 is an example of the schematic view of the design verification apparatus in accordance with the present invention.

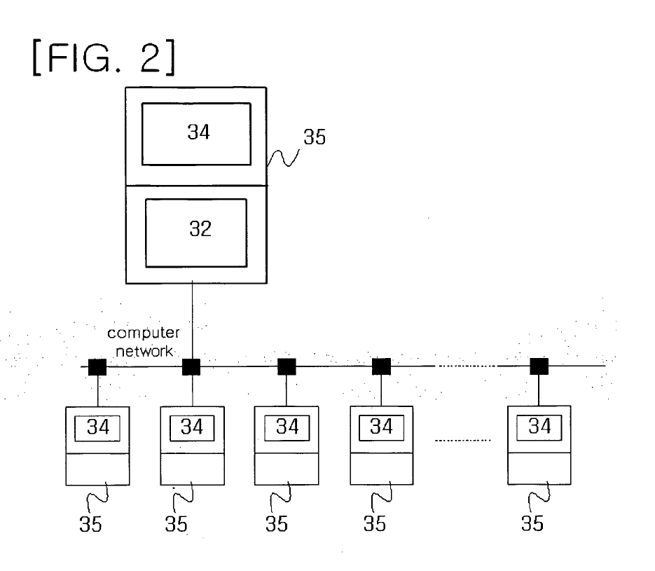

FIG. 2 is another example of the schematic view of the design verification apparatus in accordance with the present invention.

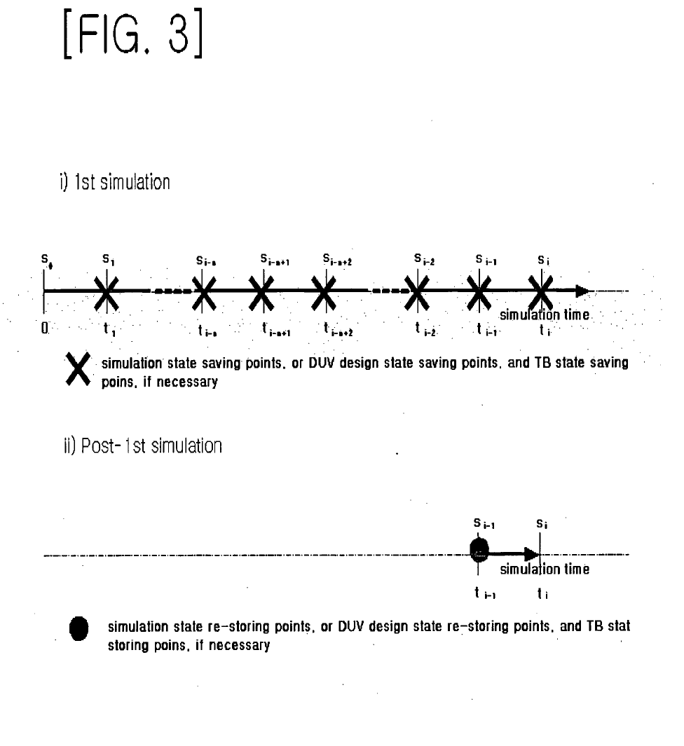

FIG. 3 is a schematic view of a simulation process by the method proposed in the present invention.

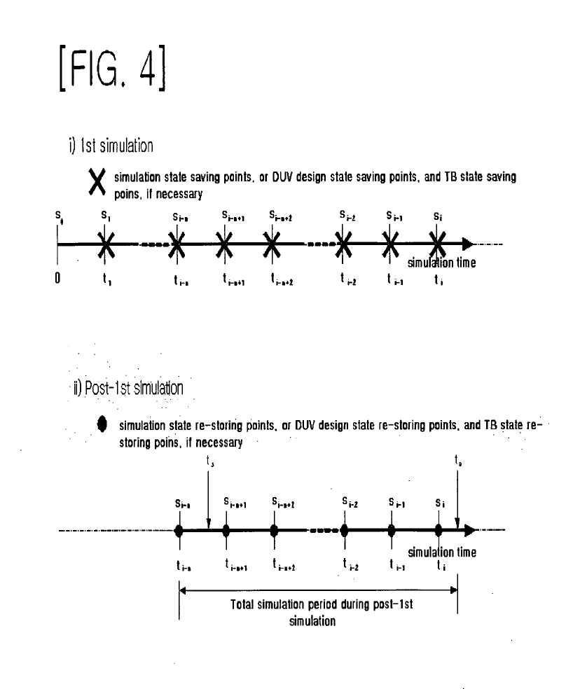

FIG. 4 is a schematic view of a bug finding and removing process throughout the simulation proposed in the present invention, which consists of the 1^{st} simulation as the front-stage simulation and the post-1^{st} simulations as the back-stage simulation.

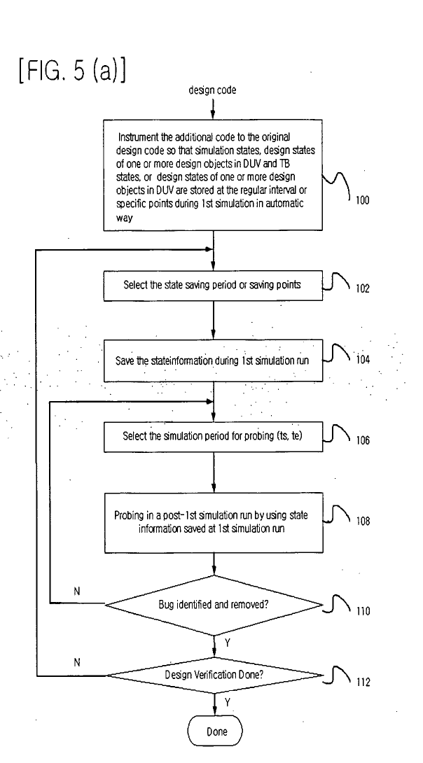

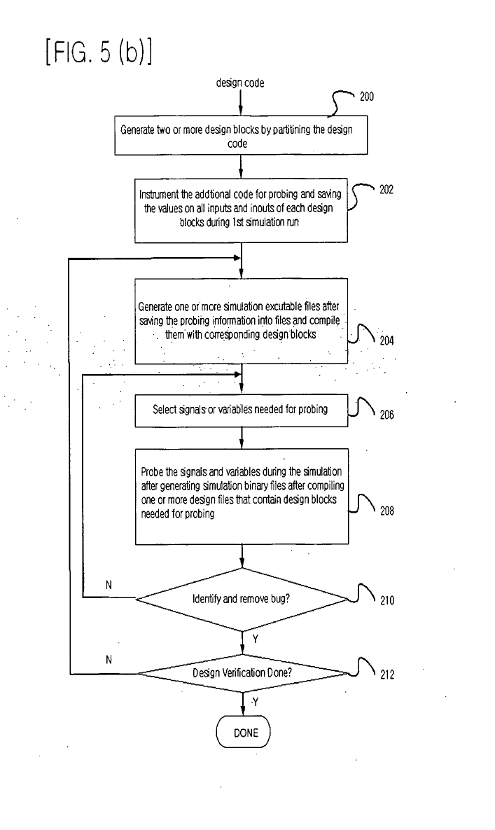

FIG. 5(a) is a schematic view showing a verification process in the verification using the apparatus showing in FIG. 1 or FIG. 2.

FIG. 5(b) is a schematic view showing another verification process in the verification using the apparatus showing in FIG. 1 or FIG. 2.

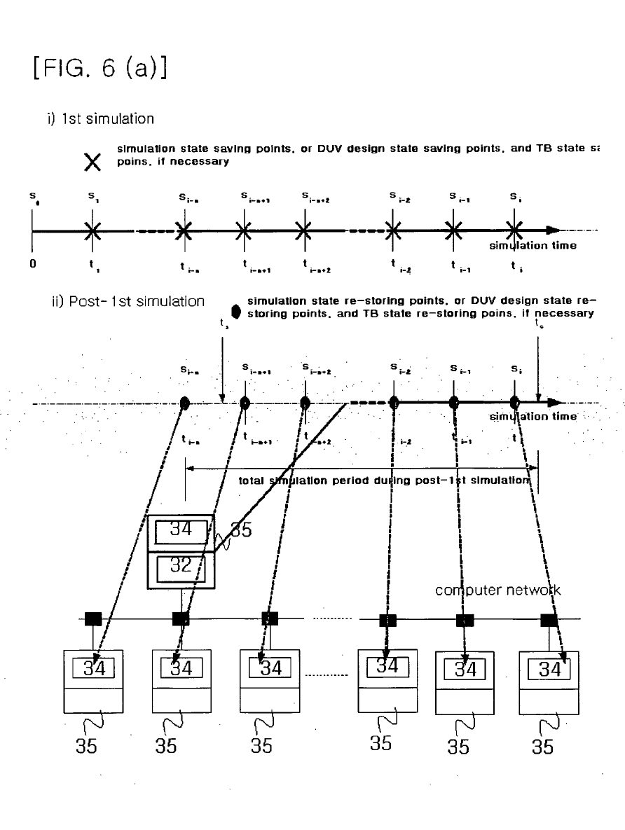

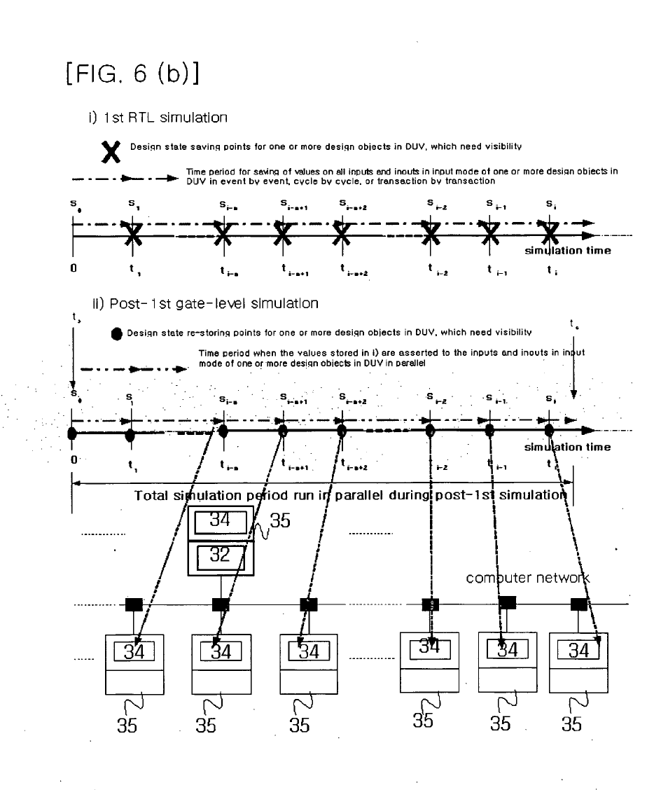

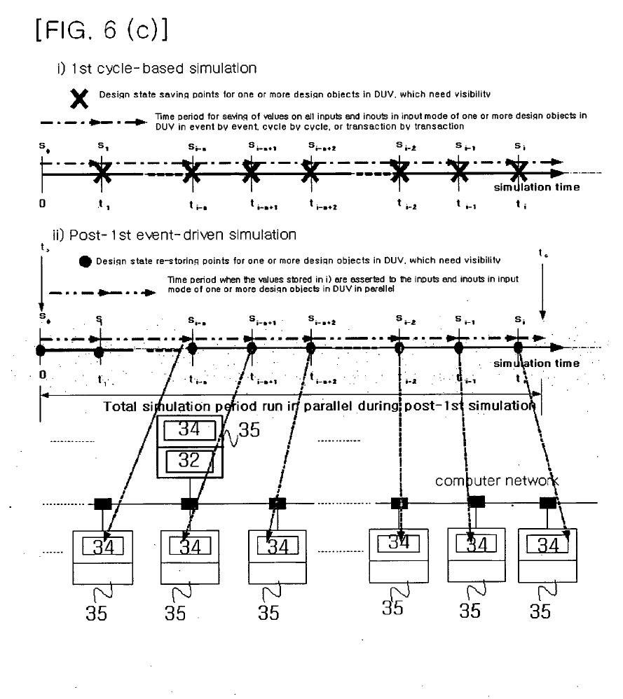

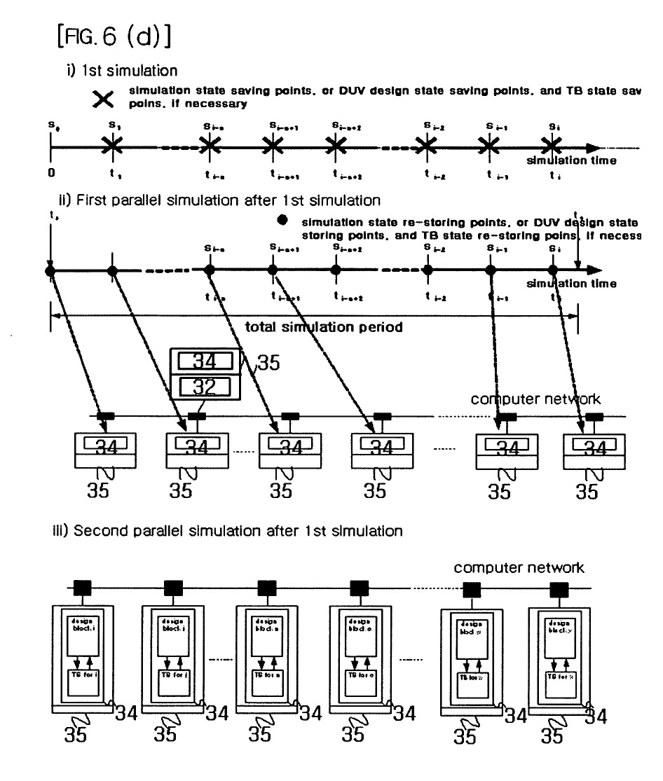

FIG. 6(a) is a schematic view showing a verification process in which the post-1^{st} simulations as the back-stage simulation are executed in parallel, using the verification apparatus in FIG. 2.

FIG. 6(b) is a schematic view showing another verification process, in which the post-1^{st} simulations as the back-stage simulation are executed in parallel, using the verification apparatus in FIG. 2.

FIG. 6(c) is a schematic view showing another verification process, in which the post-1^{st} simulations as the back-stage simulation are executed in parallel, using the verification apparatus in FIG. 2.

FIG. 6(d) is a schematic view showing another verification process, in which the post-1^{st} simulations as the back-stage simulation are executed in parallel, using the verification apparatus in FIG. 2.

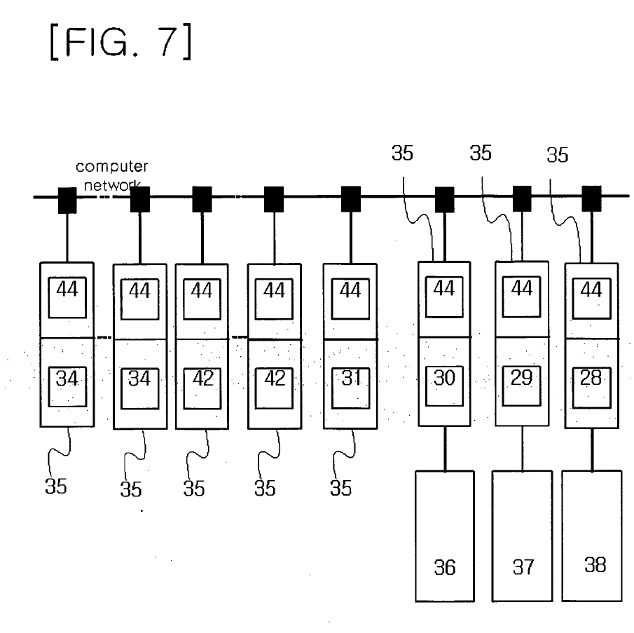

FIG. 7 is another example of the schematic view of the design verification apparatus in accordance with the present invention.

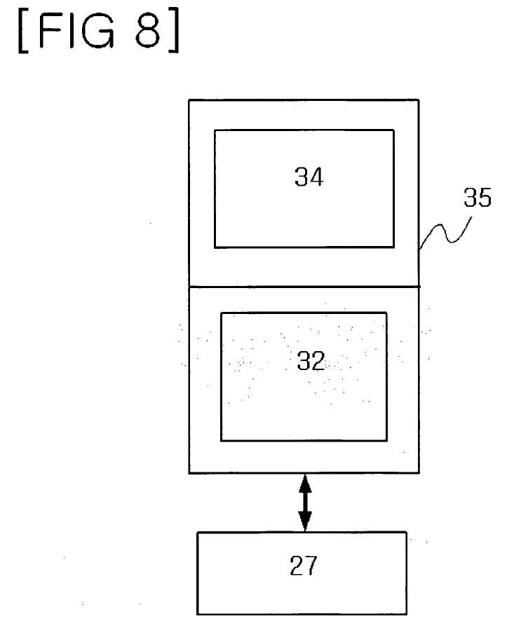

FIG. 8 is an example of the schematic view of the design verification apparatus in accordance with the present invention which consists of verification software of the present invention, at least one computer having at least one simulator, and at least one hardware-assisted verification platform.

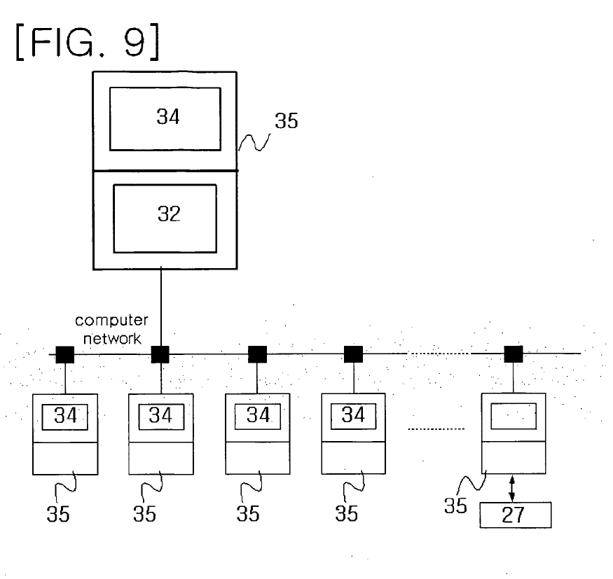

FIG. 9 is an example of the schematic view of the design verification apparatus in accordance with the present invention which consists of verification software of the present invention, at least two computers having at least two simulators, at least one hardware-assisted verification platform, and a computer network which connects among them.

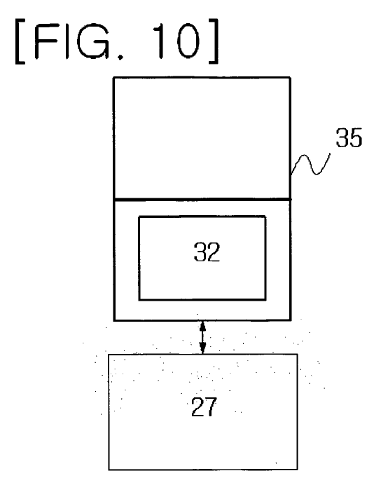

FIG. 10 is an another example of the schematic view of the design verification apparatus in accordance with the present invention which consists of verification software of the present invention, at least one computer having at least one simulator, and at least one hardware-assisted verification platform.

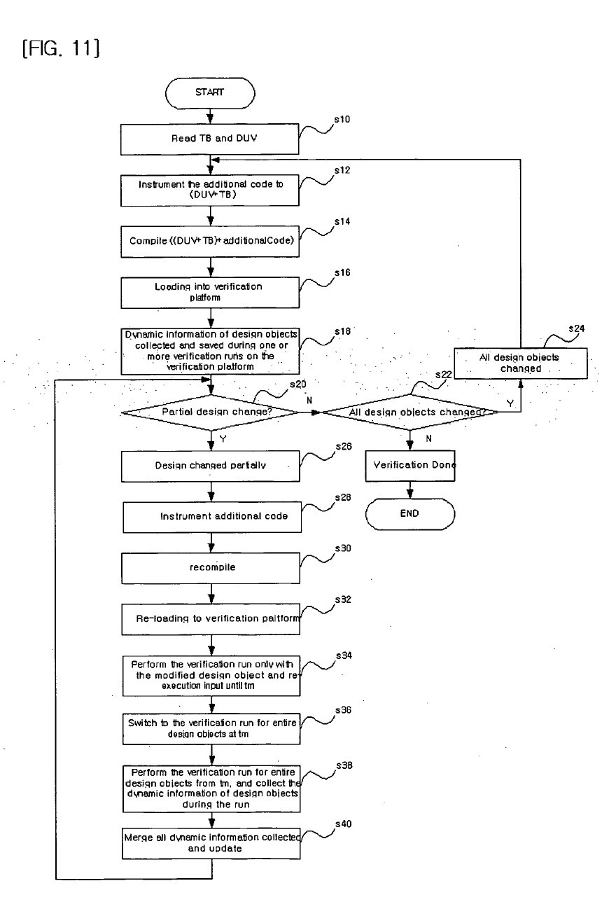

FIG. 11 is an example of the schematic view showing the reuse of the previous verification results in the verification using the apparatus in FIG. 8.

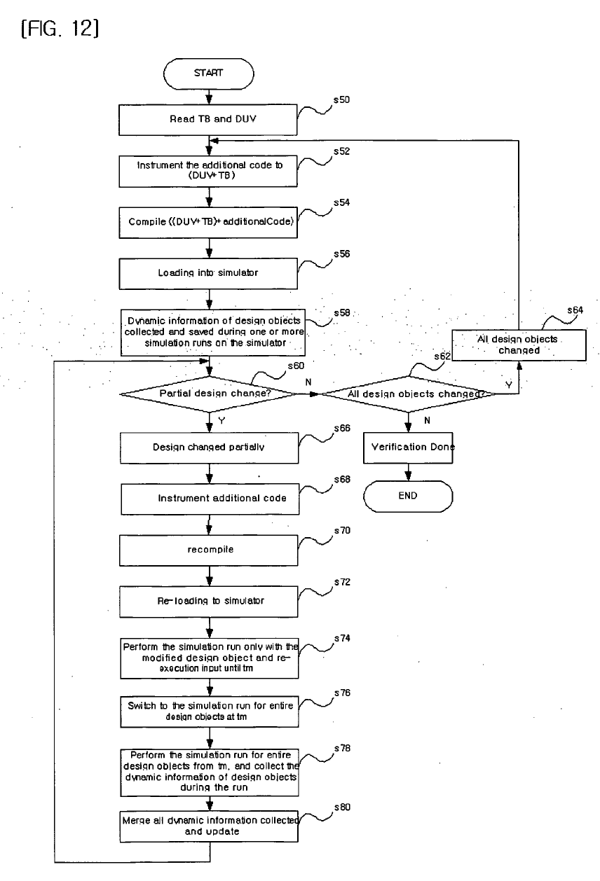

FIG. 12 is an example of the schematic view showing the reuse of the previous simulation results in the verification using the apparatus in FIG. 1.

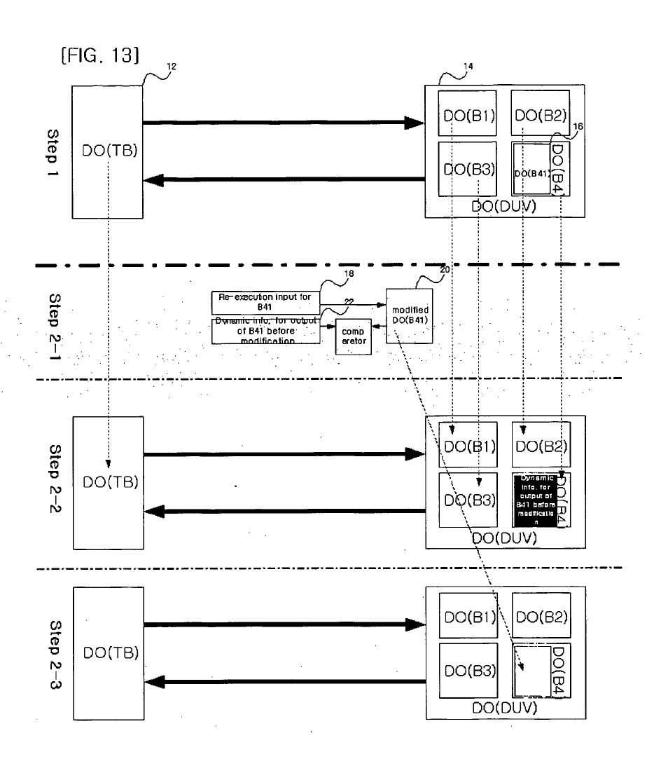

FIG. 13 is an example of the schematic view showing the fast execution of verification process by re-using the verification results of any design objects unaltered on an arbitrary verification platform after some design objects are modified.

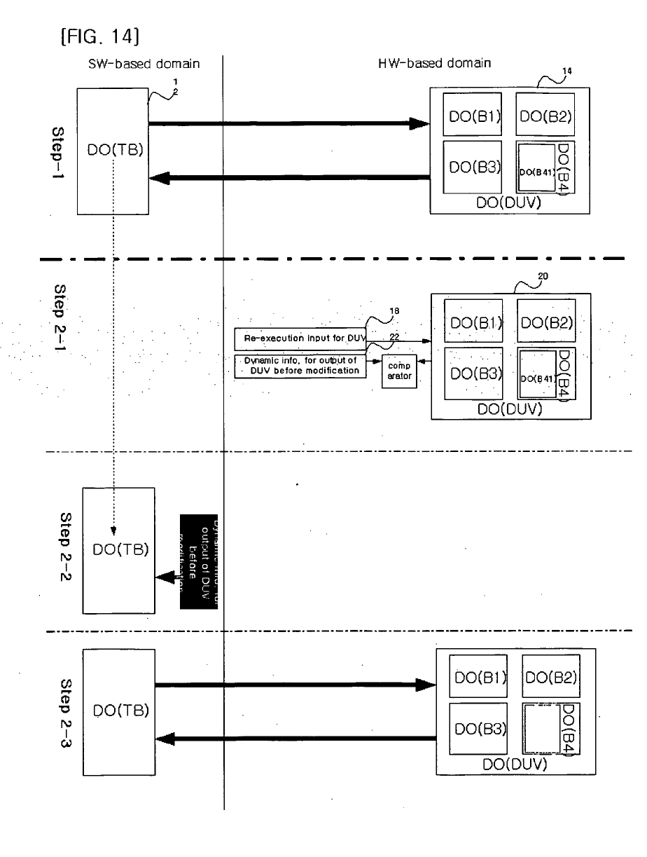

FIG. 14 is an example of the schematic view showing the fast execution of verification process by re-using the verification results of any design objects unaltered on an arbitrary hardware-assisted verification platform after some design objects are modified.

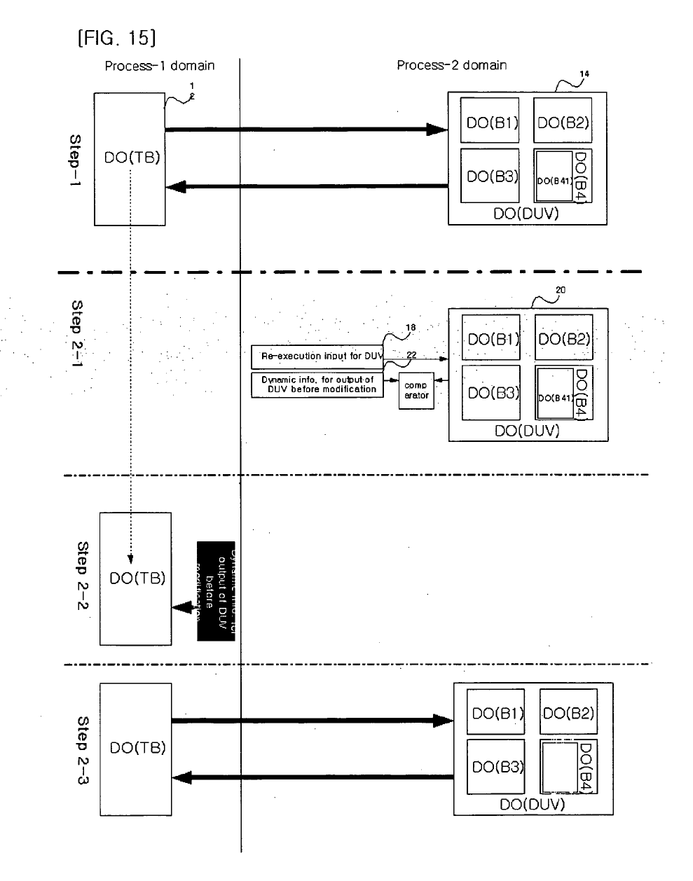

FIG. 15 is an example of the schematic view showing the fast execution of simulation process by re-using the simulation results of any design objects unaltered on a simulator after some design objects are modified.

As the present invention may be embodied in several forms without departing from the spirit or essential characteristics thereof, it should also be understood that the above-described embodiments are not limited by any of the details of the foregoing description unless otherwise specified, but rather should be construed broadly within its spirit and scope as defined in the appended claims, and therefore all changes and modifications that fall within the meets and bounds of the claims, or equivalence of such meets and bounds, are therefore intended to be embraced by the appended claims.

1-121. (canceled)

122. A design verification apparatus comprising: a verification software and one or more simulators, wherein the said verification software instruments an additional code or a circuit into the design code or into the design net-list in an automatic way, so that the necessary information (with which one or more post-1st simulations that run as the back-stage simulation can be executed against one or more design objects in the said design code or in the design net-list) can be collected during the 1st simulation run, referred to as the front-stage simulation, and the said one or more post-1st simulation runs are executed fast while obtaining the visibility, thereby providing high simulation speed or high visibility for debugging.

123. A design verification method, in which one or more design bugs in the design code or in the design net-list are identified and collected by a number of simulation executions with a number of test benches, comprising the following steps: some of said simulation executions are decomposed into the 1st simulation run as the front-stage simulation and the post-1st simulation runs as the back-stage simulation; verification software instruments an additional code or a circuit into the design code or into the design net-list in an automatic way, so that the minimally necessary information(with which one or more post-1^{st} simulations that run as the back-stage simulation can be executed against one or more design objects in the said design code or in the design net-list) can be collected during the 1st simulation run (the front-stage simulation), and said one or more post-1st simulation runs are executed fast while obtaining the visibility, thereby providing fast simulation speed or high visibility for debugging.

124. A design verification method, in which one or more design bugs in the design code or in the design net-list are identified and corrected by a number of simulation executions with a number of test benches, implemented as follows: some of the said simulation executions are decomposed into the 1st simulation run as the front-stage simulation and the post-1st simulation runs as the back-stage simulation; verification software instruments an additional code or a circuit into the design code or the design net-list in an automatic way, so that the minimally necessary information(with which one or more post-1st simulations that run as the back-stage simulation can be executed against one or more design objects in the said design code or in the design net-list) can be collected during the 1st simulation run (the front-stage simulation), and said one or more post-1st simulation runs are executed fast while obtaining the visibility, thereby providing both fast simulation speed and high visibility for debugging.

125. A design verification method, in which one or more design bugs in the design code or in the design net-list are identified and corrected by a number of simulation executions with a number of test benches, characterized in that the method is composed of the following steps: the design states of one or more design objects in DUV and, in necessary, the design states of one or more design objects in test bench are saved at one or more simulation times during one or more 1st simulation runs (the front-stage simulation), and the parallel post-1st simulation runs are executed from the saved design states as the back-stage simulation.

126. A design verification method, in which one or more design bugs in the design code or in the design net-list are identified and corrected by a number of simulation executions with a number of test benches, comprising the following steps: some of the said simulation executions are decomposed into the 1st simulation run as the front-stage simulation and the post-1st simulation runs as the back-stage simulation; verification software instruments an additional code or a circuit into the design code or the design net-list in an automatic way so that the necessary information (with which one or more post-1st simulation runs as the back-stage simulation can be executed against one or more design objects in said design code or in the design net-list) can be collected during the 1st simulation run (the front-stage simulation), and the said one or more post-1st simulation runs are executed fast while obtaining the visibility, thereby providing both fast simulation speed and high visibility for debugging.

127. The design verification method, in which a simulation at the lower level of abstraction is executed rapidly by using the simulation results from one or more simulation runs at the higher level of abstraction.

128. A design verification method according to claim 127, wherein:
one or more simulation runs at the higher level of abstraction is a transaction-level simulation and the simulation at the lower level of abstraction is a register transfer-level simulation, a gate-level simulation, a transaction/register transfer mixed-level simulation, a transaction/gate mixed-level simulation, a register transfer/gate mixed-level simulation, or a transaction/register transfer/gate-level mixed-level simulation;
one or more simulation runs at the higher level of abstraction is a register transfer-level simulation and the simulation at the lower level of abstraction is a gate-level simulation, or a mixed register transfer/gate-level simulation;
one or more simulation runs at the higher level of abstraction is a simulation based on a simple delay model and the simulation at the lower level of abstraction is a simulation based on a more accurate delay model than the said simple delay model;
one or more simulation runs at the higher level of abstraction is a cycle-based simulation and the simulation at the lower level of abstraction is an event-driven simulation, or
the said simulation results from one or more simulation runs at the higher level of abstraction which is used at a simulation at the lower level of abstraction contains either at least design state of one or more design objects so that a simulation at the lower level of abstraction is executed by the temporally parallel execution method or at least one or more input information for replay, or input/output information for replay of design objects so that a simulation at the lower level of abstraction is executed by the spatially parallel execution method.

129. A design verification apparatus comprising: a verification software and one or more simulators, wherein the said verification software instruments an additional code or a circuit into the design code or into the design net-list in an automatic way so that the necessary information (with which one or more post-1st simulation runs as the back-stage simulation can be executed against one or more design objects in the said design code or in the design net-list) can be collected during the 1st simulation run(the front-stage simulation), and the said one or more post-1st simulation runs are executed fast while obtaining the visibility, thereby providing both fast simulation speed and high visibility for debugging.

130. A design verification method, in which one or more design bugs in the design code or in the design net-list are identified and collected by a number of simulation executions with a number of test benches, comprising the following steps: some of the said simulation executions are decomposed into the 1st simulation run as the front-stage simulation and the post-1st simulation runs as the back-stage simulation; verification software instruments an additional code or a circuit into the design code or into the design net-list in an automatic way so that the necessary information (with which one or more post-1st simulation runs as the back-stage simulation can be executed against one or more design objects in the said design code or in the net-list) can be collected during the 1st simulation run, (the front-stage simulation), and the said one or more post-1st simulation runs are executed fast while obtaining the visibility, thereby providing both fast simulation speed and high visibility for debugging.

131. The design verification method, in which there is no change in the design objects, where the minimal simulation results are saved during the run of the front-stage simulation, the saved simulation results are used for running one or more back-stage simulations either in parallel with two or more simulators or in sequence with a single simulator, and, if necessary, the signal dump for one or more variables or signals in one or more design objects is carried out during the back-stage simulation, thereby achieving high visibility.

132. The design verification method, in which a simulation at the higher level of abstraction is executed in such a way that its simulation result is entirely or partially corrected by using the simulation result from a simulation at the lower level of abstraction.

133. A design verification apparatus comprising: a verification software and at least two or more different verification platforms, wherein the said verification software instruments the additional code or circuit into the design code or into the net-list in an automatic way so that the necessary information(with which one or more post-1st verification runs as the back-stage verification on the verification platforms among which at least one verification platform is different from the verification platform for the 1st verification run can be executed against one or more design objects in the said design code or net-list) can be collected during the 1st verification run, which is the front-stage verification, and the said one or more post-1st verification runs are executed fast.

134. A design verification method, in which one or more design bugs in the design code or in the design net-list are identified and corrected by running a number of verification executions using at least two or more verification platforms in a hybrid way, comprising the following steps: some of the said verification executions are decomposed into the 1st verification run as the front-stage verification and the post-1st verification runs as the back-stage verification; an additional code or a circuit is instrumented into the design code or the design net-list in an automatic way so that the necessary information (with which one or more post-1st verification runs as the back-stage verification on the verification platforms among which at least one verification platform is different from the verification platform for the 1st verification run can be executed against one or more design objects in the said design code or in the design net-list) can be collected during the 1st simulation run (front-stage simulation), and the said one or more post-1st simulation runs are executed fast as they are executed against one or more specific blocks only.

135. A design verification method, in which an additional verification uses the results from previous execution of an arbitrary simulation, simulation acceleration, hardware emulation, or prototyping, comprising the following steps” the said additional verification is decomposed into the 1st verification run as the front-stage verification and the post-1st verification runs as the back-stage verification; verification software instruments an additional code or a circuit to in the design code or into the net-list in an automatic way so that the necessary information (with which one or more post-1st verification runs as the back-stage verification can be executed against one or more design objects in the said design code or in the design net-list) can be collected during the 1st verification run, which is the front-stage verification, and the said one or more post-1st verification runs are executed fast.

136. A design verification apparatus comprising: a verification software and at least one or more verification platforms, wherein the said verification software instruments an additional code or a circuit into the design code or into the net-list in an automatic way so that the dynamic information can be collected during one or more verification runs(simulation runs or simulation acceleration runs), and the said dynamic information collected is re-used at the post-debugging simulation after at least one design object is changed for debugging, thereby entirely or partially reducing total verification time.

137. A design verification method comprising: by using a verification software and at least one or more verification platforms the additional code or circuit is instrumented into the design code or into the design net-list in an automatic way so that the dynamic information can be collected during one or more verification runs(simulation runs or simulation acceleration runs), and the collected dynamic information is re-used at the post-debugging simulation after at least one design object is changed for debugging, thereby entirely or partially reducing total verification time.

138. A design verification method according to claim 137, wherein the detection method of finding verification time in the case when the verification result of at least one design object changed for debugging differs from the verification result of the said design object before the change, includes to compare either all values of outputs and inouts of the said design object before and after the change, or compare all values of outputs of the said design object before and after the change in an automatic way, or to apply the re-simulation input stimuli(input information for replay), obtained in one or more verification runs(simulation runs or simulation acceleration runs) before modification, to the said changed design object in an automatic way, or to compare either all values of outputs and inouts of the said design object before and after the change or compare all values of outputs of the said design object before and after the change, and to apply the re-simulation input stimuli(input information for replay), obtained in one or more verification runs(simulation runs or simulation acceleration runs) before modification, to the said changed design object in an automatic way.

139. A design verification method according to claim 137, wherein the verification run(simulation run or simulation acceleration run), after at least one design object has been modified, is executed only either with the said at least one design object changed for debugging and its re-execution input stimuli or with the said at least one design object changed for debugging, its re-execution input stimuli(input information for replay) and only the part of design objects unchanged at least up to the first verification time when the verification result of at least one design object changed for debugging differs from the verification result of the said design object before the change from the verification time 0.

140. A design verification method according to claim 137, wherein the verification run(simulation run or simulation acceleration run), after at least one design object has been modified, is executed with all the design objects after the first time when the verification result of at least one design object changed for debugging differs from the verification result of the said design object before the change in an automatic way.

141. A design verification method according to claim 137, wherein the verification run(simulation run or simulation acceleration run), after at least one design object has been modified, is executed with all the design objects from the time, when the verification result of at least one design object changed for debugging differs from the verification result of the said design object before the change, to the time when the verification result of at least one design object changed for debugging becomes same as the verification result of the said design object before the change in an automatic way.

142. A design verification method according to claim 137, wherein the verification run(simulation run or simulation acceleration run) after at least one design object has been modified is executed only with the said at least one design object changed for debugging and its re-execution input stimuli(input information for replay) at least to the first verification time when the verification result of at least one design object changed for debugging differs from the verification result of the said design object before the change from the verification time 0 and after the first verification time of different results the verification run(simulation run or simulation acceleration run) is automatically switched to the verification execution with the entire design.

143. A design verification method according to claim 140, or claim 142, wherein the verification run(simulation run or simulation acceleration run) with all the design objects at the said first verification time of different results, the restoring design states for the unchanged design objects occurs with the design state information saved during the verification runs(simulation runs or simulation acceleration runs) before the modification for debugging at the particular design checkpoint, which is no later than the said first verification time of different results.

144. A design verification method according to claim 140, or claim 142, wherein the verification run(simulation run or simulation acceleration run) with all the design objects at the said first verification time of different results, the restoring design states for the unchanged design objects occurs with the design state information saved during the verification runs(simulation runs or simulation acceleration runs) before the modification for debugging at the particular design checkpoint, which is no later than the said first verification time of different results and be the closest one to the said first verification time of different results.

145. A design verification method according to claim 142, wherein the verification run(simulation run or simulation acceleration run) after design code modification, the said alignment of the dynamic information of design objects unmodified and modified at the said switching time during the verification run(simulation run or simulation acceleration run) after design code modification, or the said verification run(simulation run or simulation acceleration run) with all design objects after the said switching time after design code modification, is automatically determined by the instrumented code, which is added to the design object, during the verification run(simulation run or simulation acceleration run).
